(19) United States
(12) Patent Application Publication
(10) Pub. No.: US 2026/0111798 A1
(43) Pub. Date: Apr. 23, 2026

(54) SYSTEMS AND METHODS FOR UPDATING AND EXECUTING LANGUAGE MODELS USING INPUT FROM DISTRIBUTED COMPUTING ENVIRONMENTS

(71) Applicant: DK Crown Holdings Inc., Boston, MA (US)

(72) Inventors: Robin Mohseni, Billericay (GB); Gengyuan Zhang, Boston, MA (US)

(73) Assignee: DK Crown Holdings Inc., Boston, MA (US)

(21) Appl. No.: 19/360,328

(22) Filed: Oct. 16, 2025

Related U.S. Application Data
(60) Provisional application No. 63/708,504, filed on Oct. 17, 2024.
(60) Provisional application No. 63/708,542, filed on Oct. 17, 2024.
(60) Provisional application No. 63/708,492, filed on Oct. 17, 2024.
(60) Provisional application No. 63/708,554, filed on Oct. 17, 2024.
(60) Provisional application No. 63/708,509, filed on Oct. 17, 2024.
(60) Provisional application No. 63/708,528, filed on Oct. 17, 2024.
(60) Provisional application No. 63/711,415, filed on Oct. 24, 2024.
(60) Provisional application No. 63/719,406, filed on Nov. 12, 2024.
(60) Provisional application No. 63/741,297, filed on Jan. 2, 2025.
(60) Provisional application No. 63/741,671, filed on Jan. 3, 2025.

(51) Int. Cl. G06N 20/00; H04L 51/02

(52) U.S. Cl. CPC G06N 20/00; H04L 51/02

(57) ABSTRACT

Described herein are interactive systems and methods for training language models using input from distributed computing environments. The system can receive prompts for a language model. Each prompt can include at least one common term corresponding to an intent relating to wagers. The system can determine that the language model has not been updated using training examples that include the at least one common term corresponding to the intent. The system can generate, using the prompts and additional information corresponding to the at least one common term, a set of training examples. Each set of training examples can include a respective prompt having the at least one common term. The system can update the language model using the set of training examples.

### CROSS-REFERENCES TO RELATED APPLICATIONS

This application claims the benefit of and priority to U.S. Provisional Patent Application No. 63/741,297, filed Jan. 2, 2025; and claims the benefit of and priority to U.S. Provisional Patent Application No. 63/708,509, filed Oct. 17, 2024; and claims the benefit of and priority to U.S. Provisional Patent Application No. 63/708,492, filed Oct. 17, 2024; and claims the benefit of and priority to U.S. Provisional Patent Application No. 63/708,528, filed Oct. 17, 2024; and claims the benefit of and priority to U.S. Provisional Patent Application No. 63/708,542, filed Oct. 17, 2024; and claims the benefit of and priority to U.S. Provisional Patent Application No. 63/708,504, filed Oct. 17, 2024; and claims the benefit of and priority to U.S. Provisional Patent Application No. 63/711,415, filed Oct. 24, 2024; and claims the benefit of and priority to U.S. Provisional Patent Application No. 63/708,554, filed Oct. 17, 2024; and claims the benefit of and priority to U.S. Provisional Patent Application No. 63/719,406, filed Nov. 12, 2024; and claims the benefit of and priority to U.S. Provisional Patent Application No. 63/741,671, filed Jan. 3, 2025; the contents of each of which are incorporated herein by reference in their entireties for all purposes.

### BACKGROUND

Network environments can support communication between multiple computing devices using techniques such as packet-switching. Data transmitted between devices can be synchronized such that multiple devices on the same network access the same information. However, it can be challenging to efficiently synchronize data transmission for graphical elements using conventional networking technology.

### SUMMARY

At least one aspect of the present disclosure is directed to a system. The interactive system can include one or more processors coupled to memory. The one or more processors may receive, from a plurality of client devices, a plurality of prompts for a language model. Each of the plurality of prompts can include at least one common term corresponding to an intent relating to wagers. The one or more processors may determine that the language model has not been updated using training examples that include the at least one common term corresponding to the intent. The one or more processors may generate, using the plurality of prompts and additional information corresponding to the at least one common term, a set of training examples. Each set of training examples can include a respective prompt having the at least one common term. The one or more processors may update the language model using the set of training examples.

In some implementations, the one or more processors may determine that the language model has not been updated using training examples that include the at least one common term based on a plurality of second prompts received from the plurality of client devices that indicate the language model provided incorrect output. In some implementations, the one or more processors may determine, using the language model, that the plurality of prompts cannot be classified as corresponding to the intent relating to wagers. In some implementations, the one or more processors may determine that the language model has not been updated using training examples that include the at least one common term responsive to determining that the plurality of prompts cannot be classified as corresponding to the intent relating to wagers using the language model. In some implementations, the one or more processors may determine that a number of the plurality of prompts satisfies a threshold. In some implementations, the one or more processors may generate the set of training examples for the language model responsive to determining that the number of the plurality of prompts satisfies the threshold.

In some implementations, the training examples can include an input prompt, including the at least one common term, and a corresponding output prompt. The corresponding output prompt can indicate an intent associated with the at least one common term. In some implementations, the one or more processors may associate the at least one common term with semantic data determined based on the plurality of prompts received from the plurality of client devices. In some implementations, the one or more processors may store the association in a database.

In some implementations, the one or more processors may generate variations of the set of training examples based on the plurality of prompts received from the plurality of client devices. The variations can include the at least one common term. In some implementations, the one or more processors may update the model using the variations. In some implementations, the variations can be generated according to changes in at least one of a syntactic pattern, a semantic pattern, or a contextual pattern.

In some implementations, in response to receiving a prompt from a client device, the one or more processors may retrieve information from a database based on a second prompt received from the client device of the plurality of client devices, generate an input context for the language model using the retrieved information, and generate, using the language model, a corresponding output prompt based on the input context. In some implementations, the one or more processors may store the set of training examples and corresponding outputs in a database. In some implementations, the one or more processors may update the database with indications that the language model has been trained to recognize the at least one common term.

At least one aspect of the present disclosure is directed to a method of an interactive system. The method may include receiving, from a plurality of client devices, a plurality of prompts for a language model. Each of the plurality of prompts can include at least one common term corresponding to an intent relating to wagers. The method may include determining that the language model has not been updated using training examples that include the at least one common term corresponding to the intent. The method may include generating, using the plurality of prompts and additional information corresponding to the at least one common term, a set of training examples. Each set of training examples can include a respective prompt having the at least one common term. The method may include updating the language model using the set of training examples.

In some implementations, the method may include determining that the language model has not been updated using training examples that include the at least one common term based on a plurality of second prompts received from the plurality of client devices that indicate the language model provided incorrect output. In some implementations, the method may include determining, using the language model, that the plurality of prompts cannot be classified as corresponding to the intent relating to wagers. In some implementations, the method may include determining that the language model has not been updated using training examples that include the at least one common term responsive to determining that the plurality of prompts cannot be classified as corresponding to the intent relating to wagers using the language model. In some implementations, the method may include determining that a number of the plurality of prompts satisfies a threshold. In some implementations, the method may include generating the set of training examples for the language model responsive to determining that the number of the plurality of prompts satisfies the threshold.

In some implementations, the training examples can include an input prompt, including the at least one common term, and a corresponding output prompt. The corresponding output prompt can indicate an intent associated with the at least one common term. In some implementations, the method may include associating the at least one common term with semantic data determined based on the plurality of prompts received from the plurality of client devices. In some implementations, the method may include storing the association in a database.

In some implementations, the method may include generating variations of the set of training examples based on the plurality of prompts received from the plurality of client devices. The variations can include the at least one common term. In some implementations, the method may include updating the model using the variations. In some implementations, the variations can be generated according to changes in at least one of a syntactic pattern, a semantic pattern, or a contextual pattern.

In some implementations, in response to receiving a prompt from a client device, the method may include retrieving information from a database based on a second prompt received from the client device of the plurality of client devices, generating an input context for the language model using the retrieved information, and generating, using the language model, a corresponding output prompt based on the input context. In some implementations, the method may include storing the set of training examples and corresponding outputs in a database. In some implementations, the method may include updating the database with indications that the language model has been trained to recognize the at least one common term.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form. For example, by appropriate computer programs, which may be carried on appropriate carrier media (e.g., computer readable media), which may be tangible carrier media (e.g., disks) or intangible carrier media (e.g., communications signals). Aspects may also be implemented using suitable apparatuses, which may take the form of programmable computers running computer programs arranged to implement the aspect. As used in the specification and in the claims, the singular form of “a”, “an”, and “the” include plural referents unless the context clearly dictates otherwise.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 illustrates a block diagram of an example system for training language models using input from distributed computing environments, in accordance with one or more implementations;

FIG. 2 illustrates an example flow diagram of a method for training language models using input from distributed computing environments, in accordance with one or more implementations;

FIGS. 3 and 4 illustrate an example implementation of an application interface, in accordance with one or more implementations; and

FIG. 5 illustrates a block diagram of a server system and a client computer system in accordance with an illustrative implementation.

### DETAILED DESCRIPTION

Below are detailed descriptions of various concepts related to, and implementations of, techniques, approaches, methods, apparatuses, and systems for providing interactive game experiences. The various concepts introduced above and discussed in greater detail below may be implemented in any of numerous ways, as the described concepts are not limited to any particular manner of implementation. Examples of specific implementations and applications are provided primarily for illustrative purposes.

Natural language processing techniques can be applied across a wide range of computing environments to generate responses or other outputs based on natural language prompts. Language models and other machine-learning models can be used in various applications, including but not limited real-time information retrieval interfaces, which can be limited according to processing capacity of the systems executing such machine-learning models. To perform such operations, a language model can process input data sequences that represent prompts, contextual information, and other relevant data.

As language models typically include a large number of parameters, invoking such language models typically requires significant processing resources that make language models challenging to use for certain applications (e.g., real-time or near real-time applications. The number of operations and the amount of memory used to process a prompt is generally influenced by the size of the input context provided to the language model. Input contexts can include historical exchanges, metadata, and/or external reference information that may be relevant to generating an accurate or contextually suitable output. Generating suitable outputs typically involves providing large amounts of information as input to language models, which can significantly hinder performance, both in terms of accuracy and execution performance (e.g., computing resource utilization).

Conventional techniques for supplying input contexts to language models fail to ameliorate these issues. For example, conventional approaches often require sending large contexts, which often include an entire accumulated input, across multiple requests to achieve a requested output. Increasing the size of the input context results in increased network latency and bandwidth consumption. During output generation, executing language models with large input contexts causes processor load and increased memory allocation that grow at rates that reduce the feasibility of using language model in many real-time or near real-time applications. As a result, existing systems experience limited throughput, excessive memory consumption, and elevated network resource usage.

The techniques described herein address these and other issues by generating targeted input contexts for a language model that include only data determined to be relevant to a given prompt. In general, the techniques can select prompt-specific subsets of available context data based on one or more classification processes and/or rule-based policies. By constructing an input context from only the selected subset, the techniques described herein can significantly reduce the processing resources needed to process the input context without omitting information that is pertinent to generating an accurate output. Such context selection operations can be perform in connection with session-based data persistence, such that follow-on prompts can be processed according to previously stored interaction data, in some implementations.

By selectively reducing the contents of an input context based on prompt relevance and by avoiding redundant transmission of static context data, the techniques described herein can lower processing time and memory requirements for language model execution. Network bandwidth consumption can also be reduced because only incremental or newly relevant data is transmitted for follow-on prompts, rather than the entire accumulated context. These improvements can provide faster response times for multi-turn interactions, sustain throughput in high-load scenarios, and enable the use of large-scale language models within low-latency applications where conventional approaches would exceed performance constraints.

In further detail, various implementations of the systems and methods described herein can be used to reduce processor utilization and memory consumption when processing prompts with additional contextual input via one or more language models or other machine-learning models. For example, a system can maintain one or more data structures storing specific information that can be automatically selected for inclusion in an input context of the language/machine-learning models. As noted above, the computing resources (e.g., computing time and/or memory/caching consumption) used to execute language models or other natural language processing functions on computers increase at least quadratically with the size of the input context (e.g., the input data to be processed). Executing language models using existing techniques therefore restricts the context size according to the expected/target processing time of a corresponding request. For real-time or near real-time applications, such extended delays make using language models impossible to use.

To address these challenges, the systems and methods described herein can dynamically generate an input context that includes a subset of data that can be used to carry out requested computing operations. Such automatic selection may be performed, for example, according to intent classification operations executed using additional machine-learning models and/or specific rules-based selection policies. By automatically selecting certain data to be included in the input context, the systems and methods described herein automatically limit the input context for the language model to a targeted subset of available data, thereby reducing the latency (e.g., processing time) and memory allocation required to carry out the requested operations using the language model. As a result, the systems and methods described herein operate more efficiently, and allow for the use of language models in real-time or near real-time processing applications, which would otherwise be impossible to implement using existing techniques.

In various implementations, the systems and methods described herein can train/update language models using input from distributed computing environments according to the improved input contexts described herein. In existing systems, language models may misunderstand or misinterpret information that is not necessarily present in its training dataset. The present solutions can implement various machine learning techniques, including supervised methods like reinforcement learning and unsupervised methods such as clustering, to train the language model to avoid generating false or misleading statements from common terms or inputs across the distributed computing environments. The technical solutions can implement various unconventional approaches, including dynamic updating of databases indicating definition data and/or context information, as well as dynamic training/fine-tuning/updating of language model parameters, to facilitate processing of various input terms. Additionally, the technical solutions described herein can address the challenge of hallucinations in the language model outputs, where the model generates responses that are plausible but incorrect.

For example, by generating improved input contexts, which may be based on previously classified intent of input data, with particular data from up-to-date data sources using structured input, the systems and methods described herein can reduce the likelihood of hallucinatory responses from the language model. Some implementations described herein can perform additional training and fine-tuning processes that update the language models to adapt to new data and correct any inaccuracies in their responses. Unlike conventional approaches, which fail to produce accurate and consistent language model output, the techniques described herein can process data for the language models to reduce instances of hallucinations and increase output precision and accuracy.

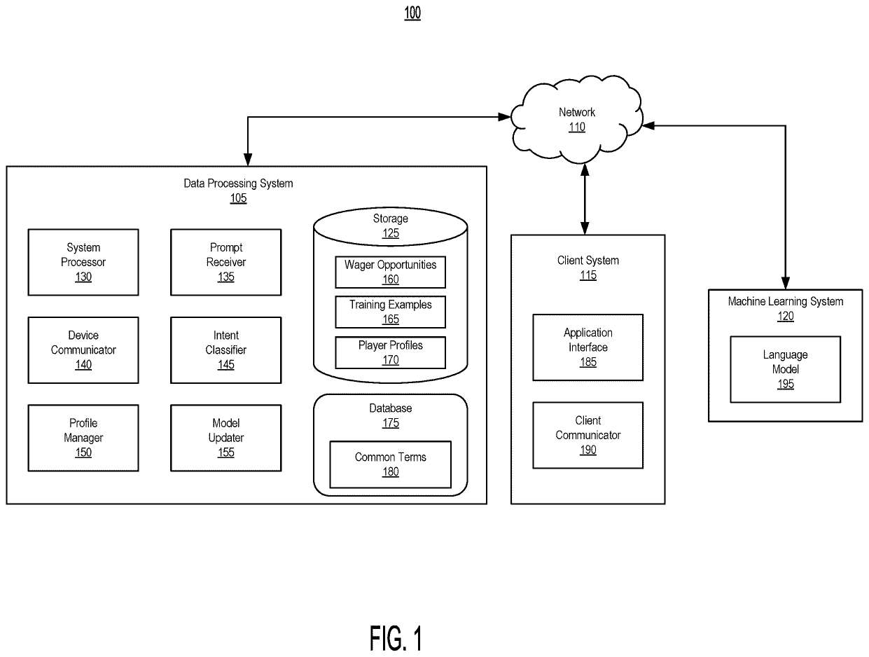

Referring to FIG. 1, depicted is a block diagram of an example system 100 for training, updating, or fine-tuning language models using input from distributed computing environments. In FIG. 1, the system 100 can include at least one data processing system 105, at least one network 110, at least one client system 115, and at least one machine learning system 120. In FIG. 1, the data processing system 105 can include at least one storage 125, at least one system processor 130, at least one prompt receiver 135, at least one device communicator 140, at least one intent classifier 145, at least one profile manager 150, at least one model updater 155, and at least one database 175. The storage 125 can include one or more wager opportunities 160, one or more training examples 165, and one or more player profiles 170. The database 175 can include one or more common terms 180. The client system 115 can include at least one application interface 185 and at least one client communicator 190. The machine learning system 120 can include at least one language model 195.

The data processing system 105 can include a physical computer system operatively coupled or couplable with one or more components of the system 100. The data processing system 105 can include a cloud system, a server, a distributed remote system, or any combination thereof. The data processing system 105 can include a virtual computing system, an operating system, and a communication bus to effect communication and processing. The data processing system 105 can include physical infrastructure, such as physical servers, storage devices, and network equipment housed in data centers. The data processing system 105 can include a virtual computing system, which can include cloud-based virtual machines or containers for running applications and services. The data processing system 105 can include an operating system that can function as the core manager, allocating resources, configuring processes, and facilitating interaction between hardware and applications. The data processing system 105 can include a communication bus that can facilitate communication between different components within the system. The data processing system 105 can connect with external systems to allow for data exchange and service delivery to end users.

The client system 115 (sometimes referred to as a “client device 115”) can include a computing system that can be used to access the functionality of the data processing system 105. The client system 115 can include a smart phone, mobile device, laptop computer, desktop computer, one or more servers, or any other type of computing device. The client system 115 can include at least one processor and a memory, e.g., a processing circuit. The memory can store processor-executable instructions that, when executed by the processor, cause the processor to perform one or more of the operations described herein. The processor can include a microprocessor, an ASIC, an FPGA, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language.

The client system 115 can include one or more devices to receive input from a user and/or to provide output to a user. For example, the output capabilities of the application interface 185 can be presented by a display device that provides visual feedback to the user. The display device can enhance the user experience with electronic displays, such as liquid crystal displays (LCD), light-emitting diode (LED) displays, or organic light-emitting diode (OLED) displays. The electronic displays can implement interactive features, including capacitive or resistive touch input, allowing for multi-touch functionality. The input functionalities can include a keyboard, mouse, or an integrated touch-sensitive panel on the display device, but are not limited thereto.

The machine learning system 120 can include one or more machine learning models trained on datasets. The machine learning system 120 can include a cloud system, a server, a distributed remote system, or any combination thereof. The machine learning system 120 can include, but is not limited to including, at least a central processing unit (CPU), a graphics processing unit (GPU), a tensor processing unit (TPU), or the like. The machine learning system 120 can include a memory operable to store one or more instructions for operating components of the machine learning system 120 and operating components operably coupled to the machine learning system 120. For example, the instructions can include firmware, software, hardware, operating systems, or embedded operating systems, among others. The machine learning system 120 can be internal to the data processing system 105. The machine learning system 120 can exist external to the data processing system 105 and can be accessed via the network 110. In some implementations, the machine learning system 120 implements or otherwise provides access to one or more application programming interfaces (APIs), via which the data processing system 105 and/or the client system 115 can access the language model 195 or other functionality of the machine learning system 120.

The network 110 can include computer networks such as the Internet, local, wide, metro, or other area networks, intranets, satellite networks, other computer networks such as voice or data mobile phone communication networks, and combinations thereof. The data processing system 105 of the system 100 can establish a communication session via the network 110, for example, with the client systems 115 and/or the machine learning system 120. Establishing a communication session can refer to creating a temporary connection between two or more devices to exchange information. For example, this can include setting up a data exchange session between the client system 115 and the data processing system 105. The network 110 may be any form of computer network that can relay information between the data processing system 105, the client system 115, the machine learning system 120, and one or more information sources, such as web servers or external databases, amongst others.

The network 110 can include the Internet and/or other types of data networks, such as a local area network (LAN), a wide area network (WAN), a cellular network, a satellite network, or other types of data networks. The network 110 can include any number of computing devices (e.g., computers, servers, routers, network switches, etc.) that are configured to receive and/or transmit data within the network 110. The network 110 can further include any number of hardwired and/or wireless connections. Any or all of the computing devices described herein (e.g., the data processing system 105, the client system 115, the machine learning system 120, etc.) can communicate wirelessly (e.g., via Wi-Fi, cellular, radio, etc.) with a transceiver that is hardwired (e.g., via a fiber optic cable, a CAT5 cable, etc.) to other computing devices in the network 110. Any or all of the computing devices described herein can communicate wirelessly with the computing devices of the network 110 via a proxy device (e.g., a router, network switch, or gateway).

The data processing system 105 can include the storage 125. The storage 125 can be a computer-readable memory that can store or maintain any of the information described herein. The storage 125 can store data associated with the system 100. The storage 125 can include one or more hardware memory devices to store binary data, digital data, or the like. The storage 125 can include one or more electrical components, electronic components, programmable electronic components, reprogrammable electronic components, integrated circuits, semiconductor devices, flip flops, arithmetic units, or the like. The storage 125 can include at least one of a non-volatile memory device, a solid-state memory device, a flash memory device, or a NAND memory device. The storage 125 can include one or more addressable memory regions disposed on one or more physical memory arrays. A physical memory array can include a NAND gate array disposed on, for example, at least one of a particular semiconductor device, an integrated circuit device, or a printed circuit board device. In an aspect, the storage 125 can correspond to a non-transitory computer readable medium. In an aspect, the non-transitory computer readable medium can include one or more instructions executable by the system processor 130.

In some implementations, the storage 125 can store, modify, or otherwise maintain any of the information described herein using one or more databases. The storage 125 can be accessed using one or more memory addresses, index values, or identifiers of any item, structure, or region maintained in the storage 125. The storage 125 can be accessed by the components of the data processing system 105, the client system 115, the machine learning system 120, or any other computing device described herein, via the network 110. The storage 125 can be internal to the data processing system 105. The storage 125 can exist externally to the data processing system 105 and can be accessed via the network 110. For example, the storage 125 can be distributed across many different computer systems (e.g., a cloud computing system) or storage elements and may be accessed via the network 110 or a suitable computer bus interface.

The data processing system 105, the client system 115, or the machine learning system 120 can store in the storage 125 the results of any or all computations, determinations, selections, identifications, generations, constructions, or calculations in one or more data structures indexed or identified with appropriate values. Any or all values stored in the storage 125 can be accessed by any computing device described herein, such as the data processing system 105, the client system 115, or the machine learning system 120, to perform any of the functionalities or functions described herein. In implementations where the storage 125 forms a part of a cloud computing system, the storage 125 can be a distributed storage medium in a cloud computing system and can be accessed by any of the components of the data processing system 105, the client system 115, the machine learning system 120, or by any other computing devices described herein.

The storage 125 can store wager opportunities 160 for one or more live events. The wager opportunities 160 can include event information, identifying the specific live event each wager is tied to, such as team names, game details, etc. The wager opportunities 160 can include wager options, including different types of bets available for each event, such as moneyline, point spread, or over/under, among other markets. The wager opportunities 160 can include odds, for example, the payout ratio associated with each wager and how much a winning wager would return. The wager opportunities 160 can include an indication of a live event. The live event can function as an identifier or reference, pointing to a specific ongoing live event from the available selections. The wager opportunities 160 can include an indication of a parlay or a single bet recommendation. For example, the wager opportunities 160 can include flags or markers indicating whether a wager is a parlay or a single bet. The wager opportunities 160 can include a record of the number of wagers placed. The wager opportunities 160 can include data corresponding to historical wager opportunities (e.g., past wagers) used to calculate or adjust the odds associated with the current wager opportunities.

In some implementations, odds associated with wager opportunities 160 can be dynamically adjusted based on various factors, such as live event data/developments, fluctuations in betting volume, and historical wager patterns, among others. In some implementations, upon detecting significant events, such as scores, timeouts, updates to bet slips, wagers added or removed, or legs added or removed, the data processing system 105 can recalculate and adjust wager odds. In some implementations, the data processing system 105 can track the popularity of specific wager types or specific wager opportunities, such as single game parlays, quick single game parlays (Quick SGPs), by tracking the number of times the corresponding wager types/opportunities have been selected. For example, each wager opportunity 160 can include or be associated with a counter that is incremented each time the wager opportunity is selected by a player via the data processing system 105. In some implementations, based on prompts and betting trends, the data processing system 105 can categorize or flag wager opportunities 160 as components or legs of parlay wagers.

The storage 125 can store one or more training examples 165. A training example 165 can include a collection of structured data used to train the language model 190 (or other machine learning models described herein) to perform specific tasks. The data processing system 105 can collect data from sources such as sports data providers, betting platforms, user interactions, and more, through data extraction, to generate training examples 165, as described in further detail herein. In some implementations, the data processing system 105 can address missing values, inconsistencies, and outliers to maintain data quality when generating training examples 165, for example, using data cleaning or preprocessing techniques. The data processing system 105 can aggregate data from multiple data sources to generate training examples 165.

In some implementations, the data processing system 105 can generate training examples 165 corresponding to one or more common terms 180. In some implementations, the data processing system 105 can generate training examples 165 for the language model 195 upon determining that the language model 195 has not been trained/updated/fine-tuned to understand one or more common terms 180 in a particular context, such as in the context of wager recommendations, information requests, or other domain-specific contexts. In some implementations, the training example 165 can include conversational datasets that include one or more common terms 180, which can be used for training and evaluating the language model 195. The conversational datasets can include collections of text data, historical conversation data, or comments structured in threaded conversations, such that the language model 195 can generate data structures corresponding to human-like text based on the input context of each training example 165. In some implementations, the data processing system 105 can generate artificial data to supplement training examples 165, for example, when dealing with limited data availability, through synthetic data generation. In some implementations, the data processing system 105 can assign labels or tags to data points for supervised learning tasks through labeling and annotation. In some implementations, the data processing system 105 can generate additional features or transform existing ones to improve model performance through feature engineering.

In some implementations, the training examples 165 can function as a knowledge base from which the language models 195 learn patterns and relationships, including, for example, common terms 180 in various contexts. As described in further detail herein, common terms 180 may include any type of slang, nicknames, colloquial terms, and other common references used in sports, wagering, or popular culture. The training examples 165 can include various data formats, such as text, numerical data, and structured data related to sports events, team nicknames, player aliases, betting odds, and slang used in betting communities. The training examples 165 can include an input prompt and a corresponding output prompt, where the output prompt can indicate the user's intent. The training examples 165 can be used to teach the language model 195 how to respond to user queries related to betting, for example. Each training example 165 can be structured with an input prompt, such as “What are the odds on the next basketball game?” or “Can you recommend some good betting strategies for football?”, to represent the user's query or request. The training examples 165 can include a corresponding output prompt, such as “The odds for the next racing game are as follows . . . ” or “Here are some effective betting strategies for football:” to indicate the desired response and outcome the user can seek.

In some implementations, the output prompt of the training example 165 can indicate an intent associated with at least one common term, which may include slang, a nickname of a player, a team, or other colloquial references. For example, the input prompt can include phrases, such as “What are the odds on the King?” or “Who's a good bet for the Thunderbolts this weekend?”, where “the King” may refer to a well-known player and “the Thunderbolts” may refer to a specific team. In this regard, the corresponding output prompt can provide the relevant betting information while acknowledging the common term 180, such as “The odds for Adam James, ‘the King’, in the next game are as follows . . . ” or “The Thunderbolts, Astrobots team, have favorable odds for their game this weekend,” or similar outputs. Common terms 180 may be automatically detected and used to generate additional training examples 165, which may receive or determine output prompts based input from operators of the data processing system 105 or derived from historical prompts transmitted to the data processing system 105 from one or more client systems 115.

In some implementations, the training examples 165 can include variations to user prompts. The variations can correspond to changes in at least one of a syntactic pattern, a semantic pattern, or a contextual pattern. The variations can include different versions of the same prompt, modifying or altering the grammatical structure (syntactic), the meaning or content (semantic), or the context in which the prompt is used (contextual). For example, a syntactic variation may change “What are the odds for tonight's game?” to “Can you tell me the odds for tonight's game?” A semantic variation may change the meaning, such as changing “What are the odds for tonight's game?” to “How likely is it that the Thunderbolts will win tonight?” A contextual variation may adjust the prompt from “What are the odds for tonight's game?” to “What are the odds for the Thunderbolts'final game of the season?”

The training examples 165 can be labeled (where the outcome is known) or unlabeled (where the outcome is not known), depending on the type of learning, such as supervised or unsupervised learning. In supervised learning, the training examples 165 can include labeled examples where the input may use colloquial terms referring to sporting events (e.g., “Who's a good bet for the Thunderbolts game?”), player nicknames (e.g., “What are the odds on the King tonight?”), and bet types (e.g., moneyline, spread, parlay, etc.), along with the current odds. In some implementations, the unsupervised learning techniques can be applied to identify hidden patterns within the unlabeled training examples 165, such as frequently used nicknames for certain teams, common slang in betting conversations, or identifying customer segments based on how they use colloquial terms in betting behavior. Once the training examples 165 are provided, the language model 195 can undergo an iterative learning process. For example, the language model 195 can be presented with prompts using common slang or nicknames, such as “What are the odds for the Blue Devils this weekend?” and generate predictions or classifications based on these terms.

The storage 125 can store one or more player profiles 170 associated with a user (sometimes referred to herein as a “player”) of a client system 115. A player profile 170 of a player can be a user profile that includes information about the player and information about one or more of the client systems 115 used to access the data processing system 105 using the player profile 170. For example, identifiers of the player profile 170 can be used to access the functionality of the data processing system 105 (e.g., by logging into the data processing system 105 via one or more web-based interfaces). The identifiers can include a username, a password, an e-mail address, a phone number, a personal identification number (PIN), a secret code-word, and device identifiers for use in a two-factor authentication technique, among others. The player profile 170 can store information about wagers, games, and live events that are performed by the player via the data processing system 105.

The player profile 170 can store a credit balance, wager information or side wager information (e.g., an amount of a wager/side wager, a timestamp associated with a wager/side wager, information about gaming conditions or game state information that resulted in a side wager, a client system identifier of the client system 115 that was used to place the wager/side wager, etc.). The player profile 170 can store information about the client system 115 used to access the data processing system 105, such as an IP address, a MAC address, a GUID, a player profile name (e.g., the name of a user of the client system, etc.), and device name, among others. In some implementations, the player profile 170 can be generated by the data processing system 105 in response to the player profile generation request transmitted by the client system 115 associated with a client device. The player profile generation request can include any of the player profile information described herein.

The data processing system 105 can include a database 175. The database 175 can be a computer-readable memory that can store or maintain any of the information described herein. In some implementations, the database 175 can include hardware, software, or any combination. In some implementations, the database 175 can correspond to an organized collection of data that is stored and accessed electronically. The database 175 can store data in a structured format, for example, using tables, rows, and columns. In some implementations, the database 175 can be managed by database management systems, which provide tools for data insertion, updating, deletion, and querying, among other functionalities. The database 175 can maintain large volumes of data. In some implementations, the database 175 can include physical components such as servers, storage devices, and networking equipment that store and process the database data. The database 175 can maintain data integrity and consistency.

In some implementations, the database 175 can store and maintain various common terms 180, such as slang, nicknames, colloquial references, or other commonly used phrases in sports and betting. The database 175 can maintain definitions and/or association data for the common terms 175, allowing the language model 195 to interpret and respond to prompts that incorporate such common language. The definition data can provide explanations of what each term means (e.g., “the Hawk” or “the King” may refer to a specific player or a team). The association data can associate the common terms with related entities, such as teams, players, or events (e.g., associating “The Thunderbolts” with a specific team or associating “parlay” with a particular type of wager).

In some implementations, the database 175 can store, in association with each common term 180, corresponding definition data and related metadata, such as player or team names, sports, and wager types, among others. When the data processing system 105 receives a prompt that includes a common term 180, the language model 195 can retrieve the definition and any related associations from the database 175 to determine a user's intent and generate a contextually relevant and accurate response using retrieval augmented generation techniques. For example, if a user asks, “What are the odds on the Thunderbolt this weekend?” the language model 195 may use the association data to identify that “the Thunderbolt” refers to a particular team or a player and then provide the corresponding odds associated with the upcoming live events. For example, the language model 180 may process the input prompt with the corresponding definition data to determine an intent of the prompt, as described in connection with the intent classifier 145. The intent of the prompt can be used by the data processing system 105 to perform various tasks, including searching for one or more relevant wager opportunities 160 to include an input context for the language model 195, which can generate corresponding output to respond to the input prompt, as described in further detail herein.

In some implementations, the database 175 can store communication data between the user and the language model 185. For example, the database 175 can include a record of prompts or questions submitted by the user, especially when they involve common terms, such as nicknames or slang (e.g., “What are the odds for the King tonight?”). The database 175 can maintain the language model's responses, session timestamps, summaries of the interactions, and sentiment analysis, among others. In some implementations, the database 175 may include a vector database, which can store embeddings of each common term 180 in association with corresponding text data identifying various synonyms, definition data, and/or related metadata. The data processing system 105 can use one or more retrieval augmented generation techniques to search the database 175 for the definitions/synonyms of common terms 180 should one or more common terms 180 appear in a prompt received from a client device 115.

The data processing system 105 can include the system processor 130. The system processor 130 can execute one or more instructions associated with the data processing system 105. The system processor 130 can include an electronic processor, an integrated circuit, or the like, including one or more of digital logic, analog logic, digital sensors, analog sensors, communication buses, volatile memory, nonvolatile memory, and the like. The system processor 130 can include, but is not limited to, at least one central processing unit (CPU), graphics processing unit (GPU), physics processing unit (PPU), tensor processing unit (TPU), embedded controller (EC), or the like. The system processor 130 can include a memory operable to store or storing one or more instructions for operating components of the system processor 130 and operating components operably coupled to the system processor 130. For example, the one or more instructions can include one or more of firmware, software, hardware, operating systems, or embedded operating systems. The system processor 130 or the data processing system 105 can include one or more communication bus controllers to effect communication between the system processor 130 and the other elements of the data processing system 105.

The data processing system 105 can include the prompt receiver 135. The prompt receiver 135 can be or include any script, file, program, application, set of instructions, or computer-executable code that is configured to process input data in the form of a prompt. The prompt receiver 135 can include hardware, software, or any combination thereof. A prompt can include any user-provided command, request, or text data. The prompt can include a request or information relating to bet placement, such as an indication of a wager type, a wager amount, or selecting specific live events or outcomes. The prompt receiver 135 can receive the prompt from the client system 115 in natural language (e.g., a text string). The prompt receiver 135 can receive prompts through user interactions with the application interface 175. User interactions can include clicking buttons, entering text, or using voice commands within one or more application interfaces 175, among others. In some implementations, the prompt receiver 135 can expose an API endpoint, allowing other applications or systems to send prompts in structured formats such as JSON or XML. In some implementations, the prompt receiver 135 can subscribe to a message queue where prompts are published by other components/devices of the system 100, for example, according to a publisher-subscriber communication protocol. In some implementations, the prompt receiver 135 can identify specific events or triggers, such as user actions or system state changes, which can generate prompts. In some implementations, the prompt receiver 135 can process prompts loaded from files stored on the data processing system 105.

In some implementations, the prompt receiver 135 can parse and process the prompts to extract information, such as wager type, amount, and game selections, among others. The prompt receiver 135 can execute functions based on the prompt's content. In some implementations, the prompt receiver 135 can perform validation checks. For example, the prompt receiver 135 can validate the requested wager against current betting odds or predefined rules. The prompt receiver 135 can validate the sufficiency of the user's account balance via the profile manager 150. The prompt receiver 135 can validate the timing of the bet. The prompt receiver 135 can facilitate the transmission of the wager to the service provider's backend, where the wager is logged and acted upon. The prompt receiver 135 can collect or store records of user prompts (and, in some implementations, conversation records including corresponding responses) in the storage 125 as part of one or more training examples 165 to improve the classification accuracy of the language model 195 over time, in some implementations.

In some implementations, the prompt receiver 135 can receive prompts for the language model 195 and parse them to extract relevant information, such as a common term 180. The prompt receiver 135 can identify slang, nicknames, or colloquial references within the prompt and extract the terms for further processing. For example, when the data processing system 105 receives a prompt, such as “What's the forecast for the Hawk this weekend?”, the prompt receiver 135 can identify “the Hawk” as a common term 180 and parse the received prompt accordingly. In this regard, the prompt receiver 135 can utilize predefined rule sets or custom dictionaries that store common terms, nicknames, or pattern-matching algorithms to identify and process the common terms 180. In some implementations, the prompt receiver 135 can implement contextual analysis to identify the common terms 180 based on the prompt's subject matter. In some implementations, upon extracting the information, the prompt receiver 135 can execute specific actions, such as referencing the database 175 to retrieve definition and/or association data for the common term 180. In some implementations, the prompt receiver 135 can manage multiple prompts and address a wide variety of user queries. In some implementations, such approaches may be performed by the intent classifier 145 and/or other components of the data processing system.

The data processing system 105 can include the device communicator 140. The device communicator 140 can be or include any script, file, program, application, set of instructions, or computer-executable code that is configured to facilitate communication between the data processing system 105, the client system 115, and the machine learning system 120. The device communicator 140 can include hardware, software, or any combination. The device communicator 140 can facilitate communication between the data processing system 105, the network 110, the client system 115, and/or the machine learning system 120 via one or more communication interfaces. A communication interface can include, for example, an API compatible with components of the data processing system 105, the client system 115, or the machine learning system 120.

The device communicator 140 can support various communication protocols (TCP/IP, UDP) compatible with a particular component of the data processing system 105, a particular component of the client system 115, or a particular component of the machine learning system 120. The device communicator 140 can implement multiple communication interfaces, including web sockets or messaging protocols, to accommodate a range of client applications. The device communicator 140 can facilitate data transfer through techniques such as compression, encryption, and error correction, among others. The device communicator 140 can be compatible with diverse content items and can be compatible with particular content delivery systems corresponding to particular content items, structures of data, types of data, or any combination thereof. For example, the device communicator 140 can be compatible with the transmission of text data or binary data structured according to one or more metrics or data of the application interface 175 or the client system 115. The device communicator 140 can provide the client system 115 with instructions to display lists of interactive options, such as live events, content items, or wagering opportunities.

The data processing system 105 can include the intent classifier 145. The intent classifier 145 can be or include any script, file, program, application, set of instructions, or computer-executable code that is configured to determine the classification of the request included in a user input, referred to as a prompt. The intent classifier can include hardware, software, or any combination. The intent classifier 145 can parse prompts received from the client system 115 to determine the intent of the user. In some implementations, the intent of the user can correspond to common terms 180 and wagering-related intents. For example, the intent classifier 145 can identify when a common term 180, such as a team nickname or slang, corresponds to a wagering-related intent. For a given prompt, the data processing system 105 can use the intent classifier 145 to generate an input context for the language model 195 using the prompt and its classification. The input context can include a variety of information, such as prompts, questions, or previous parts of a conversation, as well as definition data, synonyms or other related metadata associated with one or more common terms 180. The intent classifier 145 can identify the desired action or information sought by the user and generate an input context to include data related to that intent.

The intent classifier 145 may perform named entity recognition, pattern recognition, or other data extraction techniques to identify one or more common terms 180 in the prompt. In some implementations, the common term 180 may be a term that cannot be classified as a known entity, and may not necessarily have yet been used to train/update/fine-tune the language model 195. In some implementations, the intent classifier 145 can use rule-based techniques to classify the intent of one or more prompts. For instance, a rule can specify that when a prompt includes a common term 180, such as a team nickname, and is related to betting, the intent classifier 145 can categorize the intent as wager-related or as a request for information relating to the corresponding common term 180. For example, a prompt like “What are the odds for the Thunderbolts to win tonight?” can cause the intent classifier 145 to determine a wagering intent associated with checking odds. In some implementations, the intent classifier 145 can implement one or more machine-learning models, such as sparse vector machines (SVMs), naive bayes, or deep learning architectures such as recurrent neural networks (RNNs) and transformers (e.g., BERT) to automatically classify ambiguous intents of prompts and/or words/phrases thereof. The models can be trained on large datasets of user prompts and their corresponding intents. The intent classifier 145 can use the machine learning model(s) to detect the presence of any common terms 180 (e.g., terms that are not recognizable but may be referred to teams, participants, locations, or other entities).

The intent classifier 145 can process user prompts to extract the underlying intent or purpose. The intent classifier 145 can categorize the user's prompt into specific intents, such as placing a bet, checking odds, or requesting information team. The intent classifier 145 can determine the actions to fulfill the user's request based on the classified intent. In some implementations, the intent classifier 145 can identify common terms 180 within the prompt that correspond to the intent. For example, when the data processing system 105 receives a prompt, such as “What are the odds for Flamingos to win tonight?”, the intent classifier 145 can determine that the prompt is a request for wagering information, identify the specific wager type as a moneyline bet, and extract relevant details such as the team's name (in this example, Flamingos) and the game timeframe (in this example, tonight). This may be performed using the language model 195, named-entity recognition/classification models, and/or other techniques described herein.

In some implementations, the intent classifier 145 can, in response to receiving a prompt from a client device 115, retrieve relevant information from the database 175 based on a second prompt received from the same or another client system 115. For example, if a user submits a prompt, such as “What's the latest on the Hawk?”, the intent classifier 145 can retrieve previously stored semantic data from the database 175, where “the Hawk” is associated with a specific player, for example. The intent classifier 145 can generate an input context for the language model 195 using the retrieved information. In this example, the input context can include details about the specific player, recent performance statistics, or related wagering data, which may be retrieved from one or more databases storing context-related information.

In some implementations, the intent classifier 145 or the prompt receiver 135, depending on the implementation, can process user requests for payout information. For example, upon receiving a prompt about wager winnings, the intent classifier 145, via the data processing system 105, can cause the language model 195 to generate a data structure that includes the details of the payout based on the wager's outcome and odds. In some implementations, where the intent classifier 145 receives updates (e.g., updated odds for a specific wager), the intent classifier 145 can search through the existing wager data in the storage 125 to find the corresponding wager based on identifiers (e.g., player ID, wager ID, etc.).

The data processing system 105 can include the profile manager 150. The profile manager 150 can be or include any script, file, program, application, set of instructions, or computer-executable code that is configured to create, modify, delete, or otherwise manage player profiles 170 stored within the storage 125. The profile manager 150 can include hardware, software, or any combination. The profile manager 150 can store and organize player information, including account details, preferences, and gaming history, among others. The profile manager 150 can generate profile information based on data received from the client systems 115. This configuration can allow the profile manager 150 to capture activity across different interactive applications and different devices, and store records of that activity in the player profile 170. The profile manager 150 can update credit balances, game statistics, and other relevant information based on the outcomes of games played by the client system 115. The profile manager 150 can receive data about game results from the client system 115 and use this information to make adjustments to the player profile 170. The profile manager 150 can store game statistics such as the number of wins, losses, and ties, as well as the player's average bet size, win percentage, and longest winning streak, among others. In some implementations, the profile manager 150 can store records of player interactions, including prompts, responses, or conversation histories, with the language model 195.

The data processing system 105 can include the model updater 155. The model updater 155 can train, fine-tune, update, re-train, or otherwise maintain one or more machine learning models (e.g., the language model 195, etc.). The model updater 155 can include hardware, software, or any combination thereof. In some implementations, the model updater 155 can determine whether the language model 195 has not been updated using training examples 165 that include at least one common term 180 corresponding to the identified intent. In a non-limiting example, if the common term is a slang name for a sports team, such as “Thunderbolts”, instead of the official team's name, and the language model 195 provides odds for a different team when the term “Thunderbolts” is used, this may indicate the language model 195 lacks proper training for that common term.

In some implementations, the determination can be made based on prompts received from client systems associated with the client devices, which can indicate that the language model 195 provided incorrect or insufficient output. For example, if multiple (e.g., a threshold number) client devices repeatedly submit a prompt using a common term, such as “Thunderbolts”, and then correct the language model's response (e.g., I meant Team A, not Team B), it can signal that the language model 195 has not been properly trained to associate the term “Thunderbolts” with Team A, for example. In some implementations, the model updater 155 can use the language model 195 to determine whether the intent of a prompt including one or more common terms 180 received from one or more client devices 115 (e.g., a threshold number of client devices) can be classified. If the language model 195 is unable to classify the intent of the prompts (e.g., failing to identify that “Thunderbolts” refers to a team in a betting query), the model updater 155 can determine that the language model 195 has not been updated with training examples 165 that include the common term 180, such as the slang “Thunderbolts” or any other term that may prevent accurate classification of intent.

In some implementations, the model updater 155 can determine that a number of prompts satisfies a threshold. For example, if the model updater 155 receives a threshold number of reports or queries using a specific common term, such as “Thunderbolts”, and, in some implementations, the language model 195 consistently misinterprets the intent, this volume of incorrect classifications can cause the model updater 155 to update the language model 195. For instance, once the number of reports satisfies a predefined threshold, the model updater 155 can execute actions to update the language model 195. For example, the model updater 155 can automatically generate a set of training examples 165 using a plurality of prompts and additional information corresponding to at least one common term 180. Each set of training examples 165 can include a respective prompt, including the common term 180. As described herein, the training examples 165 can be used to update the trainable parameters of the language model 195, causing the language model 195 to better process slang, nicknames, colloquial terms, or other common terms 180 terms related to specific intents.

In some implementations, the additional data (e.g., definition data) corresponding to the common terms in generated training examples 165 can be generated using the language model 195 and historical prompts from client devices 115 defining the common term 180. For example, if a threshold number of prompts are received that clarify the intent of a prior prompt including the term, the language model 195 can be used (e.g., with particular instructions, etc.) to automatically generate output responses for training examples 165 that correctly use the meaning of the common term 180. In some implementations, the additional data (e.g., definition data, etc.) can be stored in the database 175 in association with the common term 180. In some implementations, the additional data may be provided via input from one or more operators of the data processing system 105.

In some implementations, the model updater 155 can use various machine learning algorithms, including supervised learning techniques, to train/fine-tune/update one or more machine-learning models (e.g., the language model 195) using labeled data or one or more training examples 165 to improve their prediction accuracy or classification capabilities. For example, the model updater 155 can update the language model 195 via the set of training examples 165, which include prompts corresponding to the common terms 180 that were previously unaccounted for. In some implementations, the model updater 155 can implement unsupervised learning techniques, such as clustering and association rule mining, to identify patterns in unlabeled data, and/or to generate labels for said unlabeled data. The model updater 155 can implement reinforcement learning techniques to update the language model 195 based on user-provided feedback or examples in one or more training examples 165.

The model updater 155 can update the machine learning models, such as the language model 195, using a dataset that includes numerous training examples 165. Each training example 165 can include an input context and a corresponding output message. The input context can include data related to wager opportunities, deep links, user behavior, common terms 180 (e.g., slang, nicknames, or colloquial phrases used in betting contexts), or any other relevant information. In some implementations, the input context can include definition data for the common terms 180, association data associating terms with relevant entities (e.g., teams, players, etc.), and related metadata to provide more context for accurate processing. The output message can define the response or outcome, including text messages, recommendations, or instructions for displaying relevant information based on the extracted common terms and associations. The configuration and training of the language model 195 can include various training parameters, such as the learning rate, number of epochs, batch size, activation functions, and regularization techniques, to improve learning and prevent overfitting.

In some implementations, the model updater 155 can associate a common term 180 with semantic data derived from prompts received from multiple client systems 115 to update the database 175. For example, if a common term, such as “the Hawk”, is frequently used in prompts, the model updater 155 can associate this term with semantic data indicating that “the Hawk” refers to a specific player, for example. Similarly, if users repeatedly refer to “the Bolts”, the model updater 155 can associate this term with the name of a particular sports team, for example. The model updater 155 can store the association (e.g., associating the common term 180 with relevant entities such as a player or team name) in the database 175, such that future prompts including these common terms 180 can be processed accurately when augmented with information stored in the database 175.

In some implementations, the model updater 155 can generate variations of the set of training examples 165 based on prompts received from client systems 115. The variations can include the common term 180 and may include changes in at least one of a syntactic pattern, semantic pattern, or contextual pattern. For example, the model updater 155 can generate variations that adjust the grammatical structure (e.g., syntactic pattern), modify or alter the meaning (e.g., semantic pattern), or change the context (e.g., contextual pattern) of the prompts, as described herein. Similar data can be stored in association with the corresponding common terms 180 in the database 175, for example, for use in generating input contexts for language models.

In some implementations, as described herein, the model updater 155 can train/update/fine-tune the language model 195 or other machine learning components to generate text formats, make recommendations, or understand user intents for prompts including one or more common terms 180 based on the training examples 165. The model updater 155 can implement various machine learning techniques, including supervised, unsupervised, and reinforcement learning, to continuously improve the performance of language model 195. In some implementations, the model updater 155 can provide instruction and training examples to the machine learning system 120, to cause the machine learning system 120 to train/fine-tune/update the language model(s) 195 according to the any suitable training/update technique.

In some implementations, the model updater 155 can generate, train, and/or update one or more adapters for the language model 195, such as a Low-Rank Adapter (LoRA), Quantized Low-Rank Adapter (QLoRA), or other adapters to train/update/fine-tune the language model 195. The model updater 155 can use LoRA to address the challenge of fine-tuning large models without updating all parameters. For example, instead of fine-tuning all the weights in the model, the model updater 155 can inject trainable low-rank matrices into each layer of the transformer architecture to reduce the number of trainable parameters or the computational load. In some implementations, the model updater 155 can extend LoRA by incorporating quantization techniques through QLoRA. For example, the model updater 155 can combine quantization with low-rank adaptation to reduce computational load. In some implementations, the model updater 155 can use prefix tuning, which adds trainable vectors to the input sequence to guide the model's attention. In some implementations, the model updater 155 can use p-tuning, which uses continuous prompts to fine-tune the model. In some implementations, the model updater 155 can use LongLoRA, a variant of LoRA, to manage longer sequences.

In some implementations, after the language model 195 has been trained with training examples 165 that include common terms 180 (e.g., slang, nicknames, etc.), the model updater 155 can store the set of training examples and their corresponding outputs in the database 175 and/or the storage 125, depending on the implementation. For example, if the language model is trained to determine that “the Hawk” is a player nickname, the training examples 165, including “the Hawk”, and the correct responses (e.g., player statistics or team information) can be stored in the database 175 and/or the storage 125. In some implementations, the model updater 155 can update the database 175 with indications that the language model 195 has successfully been updated or trained to identify the specific common term 180. For example, the database 175 and/or the storage 125 can record a flag or log entry indicating that “the Hawk” has been associated with a specific player and that the language model 195 has been updated accordingly to facilitate efficient updates and continuous refinement through additional data.

In some implementations, the language model 195 can be trained, fine-tuned, or otherwise updated via the model updater 155, to understand semantic and contextual meaning of one or more common terms 180 based on context, frequency of use, and previously learned associations. In some implementations, the language model 195 can implement semantic analysis techniques and data from various sources (such as prior user interactions or external data feeds) to infer the meaning of a common term 180. For example, after identifying “the Hawk” as a frequently used term in prompts, the language model 195 can be trained, fine-tuned, or otherwise updated to process related data, such as player statistics, game references, or team affiliations, to automatically derive definition data that associates “the Hawk” with the correct player. This definition data can be stored in the database 175 and/or the storage 125, allowing the language model 195 to recall and apply the correct meaning of the common term 180 for future prompts.

The client system 115 can execute an application that communicates with the data processing system 105. The application can present one or more application interfaces 185. The application interface 185 can include a set of rules or protocols that allow different software programs or systems to communicate with each other. The application interface 185 can provide user interfaces to facilitate interaction. Users can input information, view content, or initiate actions through the application interface 185. In some implementations, the application interface 185 can be associated with a particular client application that communicates with the data processing system 105 to process user prompts that include common terms 180, such as slangs or nicknames related to wagers, players, or teams.

The client application can include an application executing on each client system 115. The client application can include a web application, a server application, a resource, a desktop, or a file. In some implementations, the client application can include a local application (e.g., local to a client system 115), a hosted application, a software-as-a-service (SaaS) application, a virtual application, a mobile application, and other forms of content. In some implementations, the client application can include or correspond to applications provided by remote servers or third-party servers. In some implementations, the client application can process user prompts, including common terms associated with wagers or specific sports-related entities.

The application interface 185 can include graphical user interfaces or graphical elements that present content items, interaction modes, or wager recommendations. The application interface 185 can dynamically configure the graphical user interface based on the user's activities, preferences, or the identification of common terms 180 used during interactions (e.g., slangs for teams or players). The application interface 185 can receive interactions from the user, such as selections or specifications of wagers to be placed through the application interface 185. In response to receiving the interactions, the client application presenting the application interface 185 can communicate with the data processing system 105 to execute the placement of wagers. In some implementations, the application interface 185, via the client system 115, can cause the data processing system 105 to update the storage 125 to include the details of the wager counts. In some implementations, upon interaction with a graphical element, the application interface 185, via the data processing system 105, can cause the profile manager 150 to update a player profile 170 associated with the client system 115 according to the wager placed.

The client communicator 190 within the client system 115 can be similar to, and include any of the structure and functionality of, the device communicator 140 described in connection with the data processing system 105. For example, the client communicator 190 within the client system 115 can communicate with the data processing system 105 via the network 110 using one or more communication interfaces to carry out the various operations described herein. The client communicator 190 can be compatible with particular content objects and can be compatible with particular content delivery systems corresponding to particular content objects, structures of data, types of data, or any combination thereof.

The machine learning system 120 can include the language model 195. The language model 195 can be trained on text data. For instance, the language models 195 can be trained/updated/fine-tuned to perform a variety of text processing tasks, including, but not limited to, generating text, formatting instructions, comprehending and processing natural language input, and responding to queries with contextually relevant information. The language model 195 can include a transformer architecture, such as a generative pre-trained transformer (GPT) architecture. The transformer architecture can include an encoder that can process the input text and a decoder that can generate the output text. The language model 195 can include multiple layers that can operate to process and generate text. For example, embedding layers can convert words or tokens into dense vectors of fixed size, attention layers can use mechanisms such as self-attention to weigh the importance of different tokens in a sequence, and feedforward layers can apply transformations to the data to learn complex patterns. In some implementations, the language model 195 can use a self-attention mechanism to weight different parts of the input sequence when generating predictions. The language model 195 can be trained/fine-tuned/updated on various datasets (e.g., one or more training examples 165, etc.), for example, generated or updated by the model updater 155 using different learning techniques, as described herein. The language model 195 may be pre-trained using large corpuses of natural language text data, such that the language model 195 can efficiently process and provide output corresponding to natural language input.

Natural language input can have a syntactic structure in which individual words, collections of words (e.g., phrases), or relative positions of words (e.g., word order) can indicate specific meanings. The language model 195 can be trained/updated/fine-tuned to parse sentences into their grammatical components to understand the structure and relationships between words. The language model 195 can use phrasing structure rules that define how words combine to form phrases and sentences. The language model 195 can receive an input context, which can include a sequence of tokens and/or text data structured in a format compatible with an input layer of the language model 195. In some implementations, the language model 195 may include or may be associated with a tokenizer model, which can convert a text-based or media-based input context into a sequence of tokens compatible with an input layer of the language model 195. The input context may include natural language, structured data, or combinations thereof, and may specify instructions for the model to generate particular output (e.g., wager recommendations, formatting instructions, data identifying one or more common terms 180, etc., etc.) according to the techniques described herein.

In some implementations, the language model 195 can receive an input context, which can include relevant wager opportunities 160, common terms 180 (e.g., slang, nicknames), and other user-provided information identified based on the prompt. In some implementations, the input context can be generated to include data retrieved from the database 175, such as definition and association data stored in association with one or more common terms 180. For example, information associating a common term 180 such as “the Hawk” with a specific participant identifier (e.g., a participant in one or more live events, etc.) may be included in the input context. The data processing system 105 can transmit the input context to the language model 195. The machine learning system 120 can execute the language model 195 to process the input context. The language model 195 can generate an output data structure including one or more tokens representing an output message generated based on the input context. In some implementations, tokens or combinations of tokens can indicate special control data for the language model, including but not limited to the beginning/end of formatting instructions 165, the beginning of prompts/natural language text, or the beginning/end of wager opportunities, deep links 170, or any other type of data described herein.

The language model 195 can process a wide range of input formats, including but not limited to text, audio, images, video, or other modalities. In some implementations, based on the input context, the language model 195 can generate output, which can range from simple text responses to complex data structures. For example, if a user input includes a common term such as “the Hawk”, the language model 195 can use the input context to generate a response that associates the term with a specific player and provides relevant information such as player statistics or wager options. In some implementations, the language model 195 can use the input context to iteratively predict the next token, word, or phrase to generate responses in response to input contexts. For example, the language model 195 can generate follow-up questions or recommendations based on the common term detected, adjusting its response dynamically to maintain context relevance.

The language model 195 can process a wide range of input formats, including but not limited to text, audio, images, video, or other modalities. In some implementations, based on the input context, the language model 195 can generate output, which can range from simple text responses to complex data structures such as formatting instructions, or combinations thereof. In some implementations, the language model 195 can use the input context to iteratively predict the next token word or phrase to generate responses in response to input contexts. Tokens may include a numerical representation of text data, function calls, special separators/control signals, or any other data described herein. In some implementations, the language model 195 can generate instructions or commands that automatically invoke tools or functions to perform specific tasks or operations.

In some implementations, the language model 195 can process prompts and extract relevant information when receiving an update, such as removing a wager, removing legs, updating an existing wager, or adjusting a wager opportunity that includes common terms, among others. In some implementations, the language model 195 can parse the prompt to extract relevant details, such as the player ID, wager identifier, wager opportunity, and other desired changes. Based on the extracted information, the language model 195 can generate a command for the data processing system 105 to update the data structure associated with the player profile 170. In some implementations, the language model 195 can generate a command that includes a token, character, string, or phrase that functions as a signal or identifier for the data processing system 105. For example, the data processing system 105 can determine a nickname from the prompt, retrieve the associated player data, and make the wager updates.

In some implementations, the language model 195 can implement a specific format or syntax for the generated command, such as JSON or a custom format. The generated command for the data processing system 105 can include an identifier indicating the type of action to be performed (e.g., update a wager), the player ID (e.g., identifier for the player profile), the wager identifier (e.g., identifier for the specific wager being modified), the selected wager opportunity, the desired wager amount, and any other relevant details.

In some implementations, the data processing system 105 can directly execute the language model 195 as a component. The data processing system 105 can select the language model 195 based on factors, such as computational complexity, efficiency, and task-specific capabilities, among other attributes. The data processing system 105 can use data cleansing, tokenization, or other standardization techniques to maintain compatibility with the language model 195. In some implementations, the data processing system 105 can implement batch processing, data streaming, or asynchronous data management techniques to manage data flow into the language model 195. In some implementations, where the data processing system 105 is using an API to access the functionality of the language model 195, the data processing system 105 can integrate API calls into its operational workflow. In some implementations, where the data processing system 105 is deploying the language model 195 on local infrastructure, the data processing system 105 can load the language model 195 into system memory. The data processing system 105 can format incoming data to match the input structure of the language model 195.

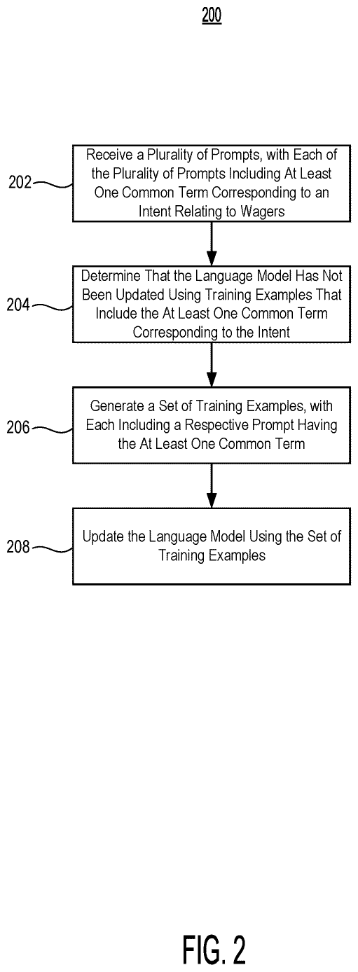

Referring now to FIG. 2, depicted is an illustrative flow diagram of a method 200 for training language models using input from distributed computing environments. The method 200 can be executed, performed, or otherwise carried out by an interactive server or an interactive system. A data processing system (e.g., the data processing system 105) can be remote to one or more client systems (e.g., the client system 115) and one or more machine learning systems (e.g., the machine learning system 120) and can communicate with the one or more client systems or the one or more machine learning systems via a computer network (e.g., the network 110). In a brief overview of method 200, the interactive server or the interactive system can receive a plurality of prompts, with each of the plurality of prompts including at least one common term corresponding to an intent relating to wagers (STEP 202), determine that the language model has not been updated using training examples that include the at least one common term corresponding to the intent (STEP 204), generate a set of training examples, with each including a respective prompt having the at least one common term (STEP 206), and update the language model using the set of training examples (STEP 208).

In further detail of method 200, the data processing system can receive a plurality of prompts, with each of the plurality of prompts including at least one common term corresponding to an intent relating to wagers (STEP 202). The common terms can include slang, nicknames, or colloquial references to teams, players, or specific types of wagers. For example, users may submit prompts such as “What are the odds for the Thunderbolts?” or “Is the Hawk playing in tonight's game?” In these examples, “the Thunderbolts” and “the Hawk” are common terms that the data processing system identifies and processes. In some implementations, the data processing system can manage multiple prompts simultaneously or sequentially, allowing for various user queries and interactions. For example, if several users are querying about different teams or players using one or more common terms, the data processing system can parse each prompt in turn, extract the relevant information, and process it accordingly. The data processing system can receive the prompts from client devices communicating via one or more communication sessions. The common term may be terms that are shared between, or otherwise common to, each of the multiple prompts received from the client devices.

The data processing system can determine that the language model has not been updated using training examples that include the at least one common term corresponding to the intent (STEP 204). In one example, the data processing system can determine that the intent of the prompt cannot properly be classified. For example, the data processing system can provide the prompt to a language model (e.g., the language model 195) with instructions to determine an intent for the prompt. In some implementations, other machine-learning models, rule-based techniques, named-entity recognition, or pattern-matching approaches can be used to classify the intent of the prompts. If the language model or other approaches cannot accurately classify the intent of the prompt the data processing system can determine that the language model has not been updated with training examples that incorporate the common term. In some implementations, the language model can generate an indication that one or more terms (e.g., common terms 180) are ambiguous or unknown in the context in which they are used. Similarly, if named-entity recognition fails to accurately classify the common terms, the data processing system can determine that the prompt includes unknown or ambiguous terms (e.g., common terms 180).

In some implementations, the data processing system can determine that the language model has not been updated using training examples based on a plurality of prompts received from multiple client devices, which can indicate that the language model provided incorrect output. For example, if several users submit prompts including a common term, and the language model consistently generates incorrect or irrelevant responses (e.g., as indicated by follow-up prompts from multiple client devices), the data processing system can determine that the language model has not been properly trained with examples including that common term. In some implementations, the data processing system can classify an intent of the subsequent prompts as indicating that a response of the language model is incorrect, according to the intent classification techniques described herein. The data processing system can track the number of corrections for one or more common terms, and can determine that the language model has not been updated to understand/contextualize a common term when the number of correction prompts satisfies a threshold number.

The data processing system can generate a set of training examples, with each including a respective prompt having the at least one common term (STEP 206). In some implementations, using the plurality of prompts and additional information corresponding to the common term, the data processing system can generate training examples to improve the language model's understanding of specific terms. In some implementations, the data processing system can determine that the number of prompts, including the common term, satisfies a predefined threshold before generating the set of training examples. Once the threshold is satisfied, the data processing system can generate the training examples. For example, if the data processing system receives a high volume of prompts referring to “the Thunderbolts” as a team nickname, the data processing system can determine that this common term is frequently used. Once the number of received prompts including “the Thunderbolts” exceeds the predefined threshold, the data processing system can initiate the generation of training examples that include that common term. In some implementations, if the data processing system receives a significant number of reports or queries using a specific common term, such as “Thunderbolts” and the language model consistently misinterprets the intent, this volume of incorrect classifications can cause the data processing system to update the language model.

In some implementations, the training examples can include an input prompt with the common term and a corresponding output prompt that indicates the intended meaning or action related to that common term. For example, if “the Hawk” is a common term for a player, the output prompt can provide details about the player's statistics or upcoming games. In some implementations, the data processing system can generate variations of the training examples, allowing the language model to identify and adapt to different syntactic, semantic, or contextual patterns in the prompts. The variations can include changes in the grammatical structure, the meaning of the term within different contexts, or shifts in how the common term is used, such that the language model can process various forms of input while maintaining accuracy.

In some implementations, the data processing system can associate at least one common term with semantic data derived from a plurality of prompts received from multiple client devices. This allows the system or the language model to identify and establish the meaning or usage of the common term based on how users employ it in their prompts. For example, if many users refer to “the Thunderbolts” in the context of a sports team, the data processing system can determine that this term is a nickname for a specific team. The data processing system can store the association between the common term and its semantics data in a database for future reference. In some implementations, when the data processing system receives a subsequent prompt from a client device, the data processing system can retrieve information from the database based on a previous prompt. For example, if a user later submits a query about “the Thunderbolts”, the data processing system can reference the stored association to understand the context and meaning of the term. The data processing system can generate an input context for the language model using the retrieved information, such as team statistics or relevant wagering details. The language model can process the input context and generate a corresponding output prompt, such as providing the latest odds for the Thunderbolts'upcoming game.

The data processing system can update the language model using the set of training examples (STEP 208). In some implementations, the data processing system can further refine the language model by updating the language model using variations of the training examples. The variations can include different syntactic, semantic, or contextual patterns of how the common term is used. For example, if “the Thunderbolts” is a common term for a team, variations can include prompts that use different sentence structures or contexts in which the team is mentioned. In some implementations, the data processing system can store the set of training examples and the corresponding outputs in a database. The database can allow for future reference and validation of the training process. In some implementations, the data processing system can update the database with indications that the language model has been trained to recognize the specific common term, such as “the Thunderbolts” or “the Hawk”, such that the language model can process similar prompts efficiently in the future.

In some implementations, upon determining the meaning of a common term, the definition data can be stored in a database (e.g., the database 175) in association with the common term. To accurately respond to prompts including the common term, the data processing system can detect that a prompt includes the common term prior to providing the prompt to the language model. The data processing system can augment the prompt with definition data indicating the proper definition and contextual meaning of the common term in the prompt, and use the augmented prompt to generate an input context for the language model according to the techniques described herein.

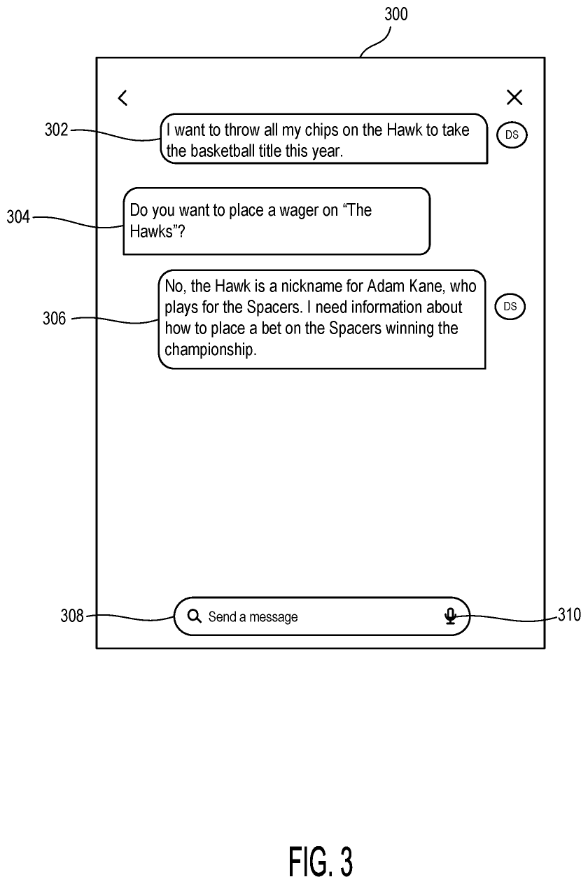

Referring now to FIG. 3, depicted is an example implementation of an application interface, as described in connection with FIGS. 1-2. As shown, a graphical user interface 300 can display a prompt 302 based on a player's interaction with a message bar 308. The prompt 302 can be an initial prompt or search term entered by the player via the message bar 308. The message bar 308 can be used to input text or initiate voice commands for sending prompts 302. For example, players can type their message directly into the designated text box within the message bar 308, or they can use a microphone icon 310 to dictate their prompts. In this example, the prompt 302 reads, “I want to throw all my chips on the Hawk to take the basketball title this year”, indicating the player's intent to collect information or place a wager on a specific entity. However, the term “the Hawk” is ambiguous to the language model 195 because the language model 195 has not encountered this term as a reference to a player or a team during its initial training. For example, in the data used to train the language model 195, the term “the Hawk” has not been associated with a specific player or a specific team, and as a result, the language model 195 cannot accurately infer the user's intent based on the term. Instead, the language model 195 relies on its existing training examples, where the closest resembling term is “the Hawks”, which refers to a team, and therefore generates an output 304 such as, “Do you want to place a wager on ‘The Hawks’?”.

In this instance, the user corrects the output 304 of the language model 195, clarifying that “the Hawk” is a nickname for a player named Adam Kane, who plays for the Spacers. As shown, the second prompt 306 reads, “No, the Hawk is a nickname for Adam Kane, who plays for the Spacers. I need information about how to place a bet on the Spacers winning the championship”. The data processing system 105, upon receiving the second prompt 306, can initiate a process to update the language model 195. For example, the model updater 155 can associate “the Hawk” with a specific player (in this example Adam Kane) and a specific team (in this example Spacers) using semantic data based on the prompt received. The model updater 155 can generate training examples to indicate the updated association, where prompts including the common term “the Hawk” correctly reference Adam Kane. As described herein, the data processing system 105 may determine that the language model is to be updated based on threshold number of prompts correcting “the Hawk” being received from one or more client devices 115. The training examples can be stored in the database 175 and/or storage 125, depending on the implementation, and can include variations in the way the common term is used, such that future prompts, whether phrased differently or within different contexts, are accurately processed by the language model 195. In some implementations, the contextual information for “the Hawk” may be stored in association with “the Hawk” (which is a common term 180) in the database 175, for use in retrieval augmented generation techniques when generating input contexts for the language model 195.

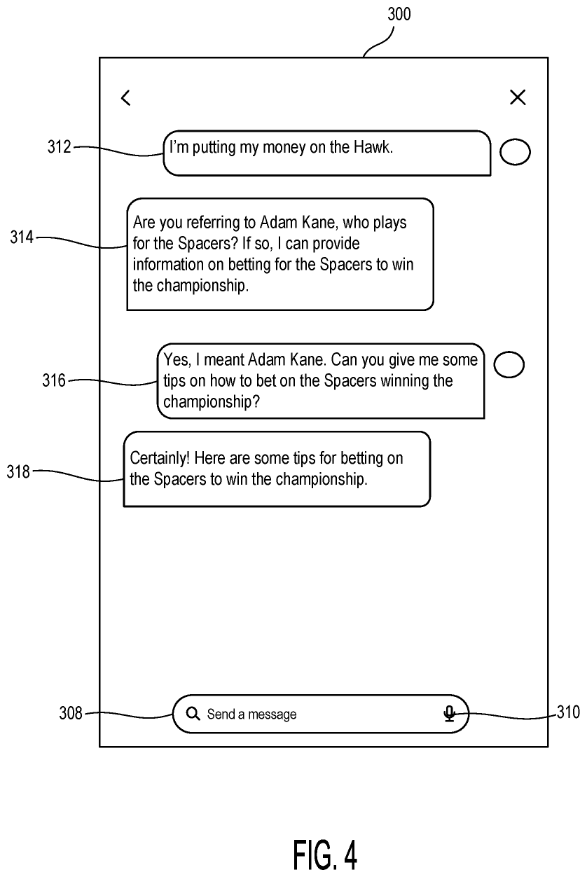

Referring now to FIG. 4, depicted is another example implementation of an application interface, building on the training of the language model 195, as described in connection with FIG. 3. For example, in FIG. 3, the model updater 155 trained the language model 195 to associate the common term “the Hawk” with Adam Kane, a player for the Spacers. In this instance, the prompt 312 reads, “I'm putting my money on the Hawk”, indicating the player's intent to place a wager. The language model 195, based on the training received in FIG. 3, processes the prompt and identifies “the Hawk” as a common term previously associated with Adam Kane. Since the association was established during training, the language model 195 can generate an output 314 such as, “Are you referring to Adam Kane, who plays for the Spacers? If so, I can provide information on betting for the Spacers to win the championship. If you meant a different team, please let me know”.

In this example, the identification process occurs because the language model 195 has been trained to recognize the common term “the Hawk” as a nickname for Adam Kane, and the language model 195 automatically derives this definition from the associated data. The data processing system 105 can retrieve the information from the stored associations in the database 175, which was updated during the training process in FIG. 3. Additionally, the player validates the output 314 of the language model 195 by responding with a second prompt 316, reading, “Yes, I meant Adam Kane. Can you give me some tips on how to bet on the Spacers winning the championship?” The language model 195, using its contextual understanding from previous training, generates a second output 318 such as, “Certainly! Here are some tips for betting on the Spacers to win the championship”. In this instance, the automatic derivation of definition data for the common terms allows the language model 195 to efficiently respond to user queries with accurate and personalized information. Although not shown here, the response from the language model may include one or more wager opportunities corresponding to Adam Kane and/or the Spacers, in this example.

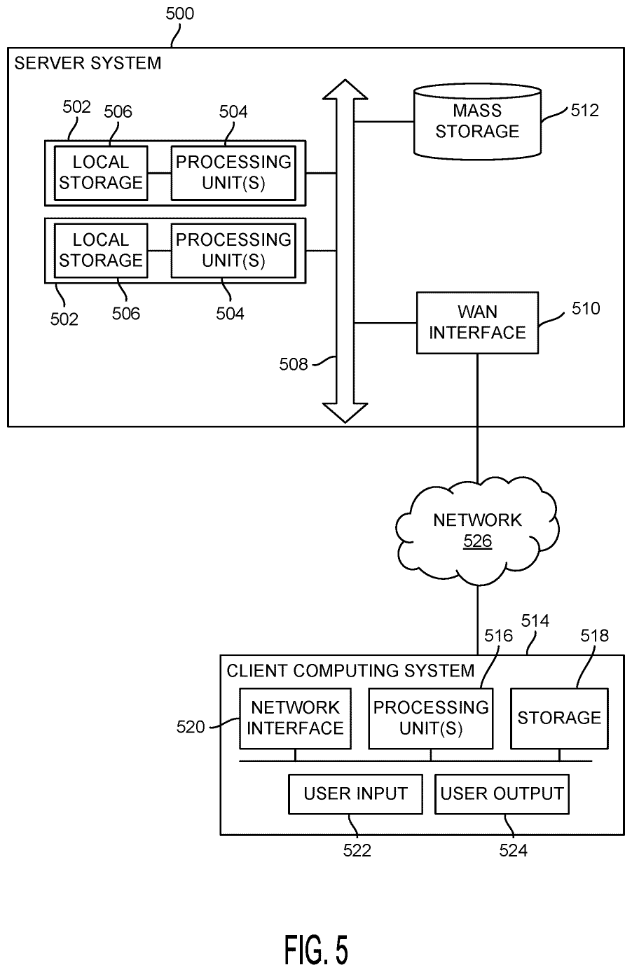

Various operations described herein can be implemented on computer systems. FIG. 5 shows a simplified block diagram of a representative server system 500, client computer system 514, and network 526 usable to implement certain implementations of the present disclosure. In various implementations, server system 500 or similar systems can implement services or servers described herein or portions thereof. Client computer system 514 or similar systems can implement clients described herein. The system (e.g., the data processing system 105) and others described herein can be similar to the server system 500.

Server system 500 can have a modular design that incorporates a number of modules 502; while two modules 502 are shown, any number can be provided. Each module 502 can include processing unit(s) 504 and local storage 506.

Processing unit(s) 504 can include a single processor, which can have one or more cores, or multiple processors. In some implementations, processing unit(s) 504 can include a general-purpose primary processor as well as one or more special-purpose co-processors such as graphics processors, digital signal processors, or the like. In some implementations, some or all processing units 504 can be implemented using customized circuits, such as application specific integrated circuits (ASICs) or field programmable gate arrays (FPGAs). In some implementations, such integrated circuits execute instructions that are stored on the circuit itself. In other implementations, processing unit(s) 504 can execute instructions stored in local storage 506. Any type of processors in any combination can be included in processing unit(s) 504.

Local storage 506 can include volatile storage media (e.g., DRAM, SRAM, SDRAM, or the like) and/or non-volatile storage media (e.g., magnetic or optical disk, flash memory, or the like). Storage media incorporated in local storage 506 can be fixed, removable or upgradeable as desired. Local storage 506 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 504 need at runtime. The ROM can store static data and instructions that are needed by processing unit(s) 504. The permanent storage device can be a non-volatile read-and-write memory device that can store instructions and data even when module 502 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some implementations, local storage 506 can store one or more software programs to be executed by processing unit(s) 504, such as an operating system and/or programs implementing various server functions such as functions of the data processing systems 105 of FIG. 1 or any other system described herein, or any other server(s) associated with the data processing systems 105, or any other system described herein.

“Software” refers generally to sequences of instructions that, when executed by processing unit(s) 504 cause server system 500 (or portions thereof) to perform various operations, thus defining one or more specific machine implementations that execute and perform the operations of the software programs. The instructions can be stored as firmware residing in read-only memory and/or program code stored in non-volatile storage media that can be read into volatile working memory for execution by processing unit(s) 504. Software can be implemented as a single program or a collection of separate programs or program modules that interact as desired. From local storage 506 (or non-local storage described below), processing unit(s) 504 can retrieve program instructions to execute and data to process in order to execute various operations described above.

In some server systems 500, multiple modules 502 can be interconnected via a bus or other interconnect 508, forming a local area network that supports communication between modules 502 and other components of server system 500. Interconnect 508 can be implemented using various technologies including server racks, hubs, routers, etc.

A wide area network (WAN) interface 510 can provide data communication capability between the local area network (interconnect 508) and the network 526, such as the Internet. Technologies can be used, including wired (e.g., Ethernet, IEEE 502.3 standards) and/or wireless technologies (e.g., Wi-Fi, IEEE 502.5 standards).

In some implementations, local storage 506 is intended to provide working memory for processing unit(s) 504, providing fast access to programs and/or data to be processed while reducing traffic on interconnect 508. Storage for larger quantities of data can be provided on the local area network by one or more mass storage subsystems 512 that can be connected to interconnect 508. Mass storage subsystem 512 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 512. In some implementations, additional data storage resources may be accessible via WAN interface 510 (potentially with increased latency).

Server system 500 can operate in response to requests received via WAN interface 510. For example, one of modules 502 can implement a supervisory function and assign discrete tasks to other modules 502 in response to received requests. Work allocation techniques can be used. As requests are processed, results can be returned to the requester via WAN interface 510. Such operation can generally be automated. Further, in some implementations, WAN interface 510 can connect multiple server systems 500 to each other, providing scalable systems capable of managing high volumes of activity. Techniques for managing server systems and server farms (collections of server systems that cooperate) can be used, including dynamic resource allocation and reallocation.

Server system 500 can interact with various user-owned or user-operated devices via a wide-area network such as the Internet. An example of a user-operated device is shown in FIG. 5 as client computing system 514. Client computing system 514 can be implemented, for example, as a consumer device such as a smartphone, other mobile phone, tablet computer, wearable computing device (e.g., smart watch, eyeglasses), desktop computer, laptop computer, and so on.

For example, client computing system 514 can communicate via WAN interface 510. Client computing system 514 can include computer components such as processing unit(s) 516, storage device 518, network interface 520, user input device 522, and user output device 424. Client computing system 514 can be a computing device implemented in a variety of form factors, such as a desktop computer, laptop computer, tablet computer, smartphone, other mobile computing device, wearable computing device, or the like.

Processor 516 and storage device 518 can be similar to processing unit(s) 504 and local storage 506 described above. Suitable devices can be selected based on the demands to be placed on client computing system 514; for example, client computing system 514 can be implemented as a “thin” client with limited processing capability or as a high-powered computing device. Client computing system 514 can be provisioned with program code executable by processing unit(s) 516 to enable various interactions with server system 500 of a message management service such as accessing messages, performing actions on messages, and other interactions described above. Some client computing systems 514 can also interact with a messaging service independently of the message management service.

Network interface 520 can provide a connection to the network 526, such as a wide area network (e.g., the Internet) to which WAN interface 510 of server system 500 is also connected. In various implementations, network interface 520 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 522 can include any device (or devices) via which a user can provide signals to client computing system 514; client computing system 514 can interpret the signals as indicative of particular user requests or information. In various implementations, user input device 522 can include any or all of a keyboard, touch pad, touch screen, mouse or other pointing device, scroll wheel, click wheel, dial, button, switch, keypad, microphone, and so on.

User output device 524 can include any device via which client computing system 514 can provide information to a user. For example, user output device 524 can include a display to display images generated by or delivered to client computing system 514. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some implementations can include a device such as a touchscreen that function as both input and output device. In some implementations, other user output devices 524 can be provided in addition to or instead of a display. Examples include indicator lights, speakers, tactile “display” devices, printers, and so on.

Some implementations include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 504 and 516 can provide various functionality for server system 500 and client computing system 514, including any of the functionality described herein as being performed by a server or client, or other functionality associated with message management services.

It will be appreciated that server system 500 and client computing system 514 are illustrative and that variations and modifications are possible. Computer systems used in connection with implementations of the present disclosure can have other capabilities not specifically described here. Further, while server system 500 and client computing system 514 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of these. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus”, “data processing system”, “client device”, “computing platform”, “computing device”, or “device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of these. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a player, implementations of the subject matter described in this specification can be implemented on a computer having a display device, e.g., a CRT (cathode ray tube), plasma, or LCD (liquid crystal display) monitor, for displaying information to the player and a keyboard and a pointing device, e.g., a mouse or a trackball, by which the player can provide input to the computer. Other kinds of devices can be used to provide for interaction with a player as well; for example, feedback provided to the player can include any form of sensory feedback, e.g., visual feedback, auditory feedback, or tactile feedback; and input from the player can be received in any form, including acoustic, speech, or tactile input. In addition, a computer can interact with a player by sending documents to and receiving documents from a device that is used by the player; for example, by sending web pages to a web browser on a player's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a player can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as the system(s) described herein can include clients and/or servers. For example, the system can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving input from a player interacting with the client device). Data generated at the client device (e.g., a result of an interaction, computation, or any other event or computation) can be received from the client device at the server, and vice-versa.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the system could be a single module, a logic device having one or more processing modules, one or more servers, or part of a search engine.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, elements, or acts of the systems and methods herein referred to in the singular may also embrace implementations including a plurality of these elements; and any references in plural to any implementation, element, or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The systems and methods described herein may be applied to other environments. The foregoing implementations are illustrative, rather than limiting, of the described systems and methods. The scope of the systems and methods described herein may thus be indicated by the appended claims, rather than the foregoing description, and changes that come within the meaning and range of equivalency of the claims are embraced therein.

1. A system, comprising:
one or more processors coupled to non-transitory memory, the one or more processors configured to:
receive, from a plurality of client devices, a plurality of prompts for a language model, each of the plurality of prompts comprising at least one nickname corresponding to an athlete, the at least one nickname corresponding to an intent relating to wagers, wherein the language model is a generative pretrained transformer (GPT) model and includes an encoder that processes input text and a decoder that generates output text and a plurality of trainable parameters;
determine that the language model has not been updated using training examples that include the at least one nickname corresponding to the intent;
generate, using the plurality of prompts and additional information corresponding to the at least one nickname, a set of training examples, each training example comprising a respective prompt having the at least one nickname;
update the language model using the set of training examples by applying one or more parameter-efficient fine-tuning adapters configured to modify less than all of the plurality of trainable parameters;
receive from a client device, a prompt including the at least one nickname; and
provide, using the updated language model, an output corresponding to the at least one nickname.

2. The system of claim 1, wherein the one or more processors are further configured to:
determine that the language model has not been updated using training examples that include the at least one nickname based on a plurality of second prompts received from the plurality of client devices that indicate the language model provided incorrect output.

3. The system of claim 1, wherein the one or more processors are further configured to:
determine, using the language model, that the plurality of prompts cannot be classified as corresponding to the intent relating to wagers; and
determine that the language model has not been updated using training examples that include the at least one nickname responsive to determining that the plurality of prompts cannot be classified as corresponding to the intent relating to wagers using the language model.

4. The system of claim 1, wherein the one or more processors are further configured to:
determine that a number of the plurality of prompts satisfies a threshold; and
generate the set of training examples for the language model responsive to determining that the number of the plurality of prompts satisfies the threshold.

5. The system of claim 1, wherein the training examples further comprise an input prompt comprising the at least one nickname and a corresponding output prompt, the corresponding output prompt indicating an intent associated with the at least one nickname.

6. The system of claim 1, wherein the one or more processors are further configured to:
associate the at least one nickname with semantic data determined based on the plurality of prompts received from the plurality of client devices; and
store the association in a database.

7. The system of claim 1, wherein the one or more processors are further configured to:
generate variations of the set of training examples based on the plurality of prompts received from the plurality of client devices, the variations comprising the at least one nickname; and
update the language model using the variations.

8. The system of claim 7, wherein the variations are generated according to changes in at least one of a syntactic pattern, a semantic pattern, or a contextual pattern.

9. The system of claim 1, wherein, in response to receiving a prompt from a client device, the one or more processors are further configured to:
retrieve information from a database based on a second prompt received from the client device of the plurality of client devices;
generate an input context for the language model using the retrieved information; and
generate, using the language model, a corresponding output prompt based on the input context.

10. The system of claim 1, wherein the one or more processors are further configured to:
store the set of training examples and corresponding outputs in a database; and
update the database with indications that the language model has been trained to recognize the at least one nickname.

11. A method, comprising:
receiving, by one or more processors coupled to non-transitory memory, from a plurality of client devices, a plurality of prompts for a language model, each of the plurality of prompts comprising at least one nickname corresponding to an athlete and corresponding to an intent relating to wagers, wherein the language model is a generative pretrained transformer (GPT) model and includes an encoder that processes input text and a decoder that generates output text and a plurality of trainable parameters;
determining, by the one or more processors, that the language model has not been updated using training examples that include the at least one nickname or slang term corresponding to the intent;
generating, by the one or more processors, using the plurality of prompts and additional information corresponding to the at least one nickname, a set of training examples, each training example comprising a respective prompt having the at least one nickname;
updating, by the one or more processors, the language model using the set of training examples by applying one or more parameter-efficient fine-tuning adapters configured to modify less than all of the plurality of trainable parameters;
receiving from a client device, a prompt including the at least one nickname; and
providing, using the updated language model, an output corresponding to the at least one nickname.

12. The method of claim 11, further comprising:
determining, by the one or more processors, that the language model has not been updated using training examples that include the at least one nickname based on a plurality of second prompts received from the plurality of client devices that indicate the language model provided incorrect output.

13. The method of claim 11, further comprising:
determining, by the one or more processors, using the language model, that the plurality of prompts cannot be classified as corresponding to the intent relating to wagers; and
determining, by the one or more processors, that the language model has not been updated using training examples that include the at least one nickname responsive to determining that the plurality of prompts cannot be classified as corresponding to the intent relating to wagers using the language model.

14. The method of claim 11, further comprising:
determining, by the one or more processors, that a number of the plurality of prompts satisfies a threshold; and
generating, by the one or more processors, the set of training examples for the language model responsive to determining that the number of the plurality of prompts satisfies the threshold.

15. The method of claim 11, wherein the training examples further comprise an input prompt comprising the at least one nickname and a corresponding output prompt, the corresponding output prompt indicating an intent associated with the at least one nickname.

16. The method of claim 11, further comprising:
associating, by the one or more processors, the at least one nickname with semantic data determined based on the plurality of prompts received from the plurality of client devices; and
storing, by the one or more processors, the association in a database.

17. The method of claim 11, further comprising:
generating, by the one or more processors, variations of the set of training examples based on the plurality of prompts received from the plurality of client devices, the variations comprising the at least one nickname; and
updating, by the one or more processors, the language model using the variations.

18. The method of claim 17, wherein the variations are generated according to changes in at least one of a syntactic pattern, a semantic pattern, or a contextual pattern.

19. The method of claim 11, further comprising, in response to receiving a prompt from a client device:
retrieving, by the one or more processors, information from a database based on a second prompt received from the client device of the plurality of client devices;
generating, by the one or more processors, an input context for the language model using the retrieved information; and
generating, by the one or more processors, using the language model, a corresponding output prompt based on the input context.

20. The method of claim 11, further comprising:
storing, by the one or more processors, the set of training examples and corresponding outputs in a database; and
updating, by the one or more processors, the database with indications that the language model has been trained to recognize the at least one nickname.
